(19) United States
(12) Patent Application Publication
(10) Pub. No.: US 2014/0068309 A1
(43) Pub. Date: Mar. 6, 2014

(54) ELECTRONIC DEVICE AND METHOD FOR CONTROLLING STARTUP CURRENT OF STORAGE SERVER

(71) Applicant: HON HAI PRECISION INDUSTRY CO., LTD., New Taipei (TW)

(72) Inventor: CHIH-HUANG WU, New Taipei (TW)

(21) Appl. No.: 13/911,144

(22) Filed: Jun. 6, 2013

(30) Foreign Application Priority Data
Aug. 29, 2012 (TW) 101131306

(51) Int. Cl. G06F 1/26; G06F 1/32

(52) U.S. Cl. CPC G06F 1/266; G06F 1/325
USPC 713/324

(57) ABSTRACT

In a method for controlling a startup current of a storage server, a current of each storage nodes of the storage server is detected by a current sensor when the storage server is turned on. The method calculates a power of each storage node, and a total power of the storage server. When the total power of the storage server is greater than a threshold value, one or more storage nodes are turned off, and the storage nodes are grouped according to the calculated powers. The method further determines a startup sequence of groups of the storage nodes, and controls the groups of the storage nodes to start up according to the startup sequence, to avoid inrush current when a power supply provides power to all of the storage nodes simultaneously.

### BACKGROUND

1. Technical Field

Embodiments of the present disclosure relate to power management technology, and particularly to an electronic device and method for controlling a startup current of a storage server using the electronic device.

2. Description of Related Art

For large data storage, more and more storage devices (e.g., hard disk drives) are added to a storage server, such as a rack server, for example. If too many storage devices are started up simultaneously, a startup current of the storage system may be too large, resulting in the power supply being unstable. A higher wattage power supply may solve this problem. However, the higher wattage power supply may be expensive, and the power consumption of the storage system may increase. Therefore, an efficient method for controlling a startup current of the storage server is desired.

### BRIEF DESCRIPTION OF THE DRAWINGS

FIG. 1 is a block diagram of one embodiment of an electronic device in connection with a storage server.

FIG. 2 is a block diagram of function modules of a control system in the electronic device.

FIG. 3 is a flowchart of one embodiment of a method for determining a startup sequence using the control system.

FIG. 4 is a flowchart of one embodiment of a method for controlling a startup current of the storage server using the control system.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

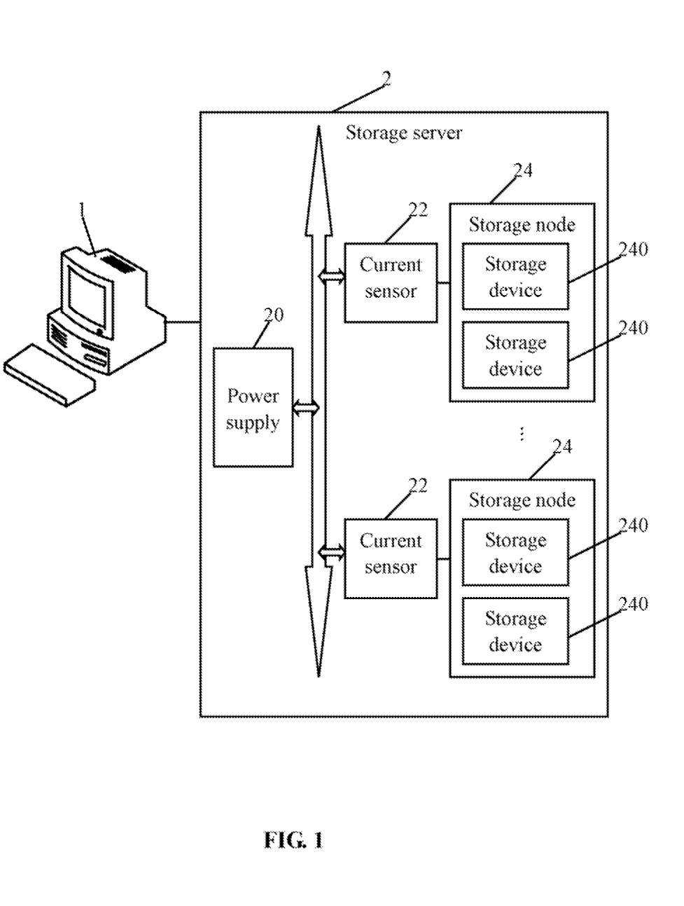

FIG. 1 is a block diagram of one embodiment of an electronic device 1 in connection with a storage server 2. The electronic device 1 may be connected to the storage server 2 through the Transmission Control Protocol/Internet Protocol (TCP/IP) connection, or other data connections or communication networks. In some embodiments, the electronic device 1 may be a computer, a tablet computer, a personal digital assistant, a notebook computer, a server, or any other computing device. The storage server 1 may be a rack server, which has multiple servers stacked one above the other.

The storage server 1 includes a power supply 20, a plurality of storage nodes 24, and a plurality of current sensors 22. Each of the current sensors 22 is connected to one of the storage nodes 24. In some embodiments, each of the storage nodes 24 has a plurality of storage devices 240. The storage devices 240 may be hard disks, or any other storage mediums. For example, each of the storage nodes 24 may have three, four, eight, twelve, or other number of storage devices 240.

The power supply 20 provides power to the storage server 2. For example, the power supply 20 supplies power to the storage devices 240 in each of the storage nodes 24, to start up the storage devices 240. Each of the current sensors 22 may detect a current of each of the storage nodes 24, and the detected current may be used to calculate a power of each of the storage nodes 24, and a total power of the storage server 2.

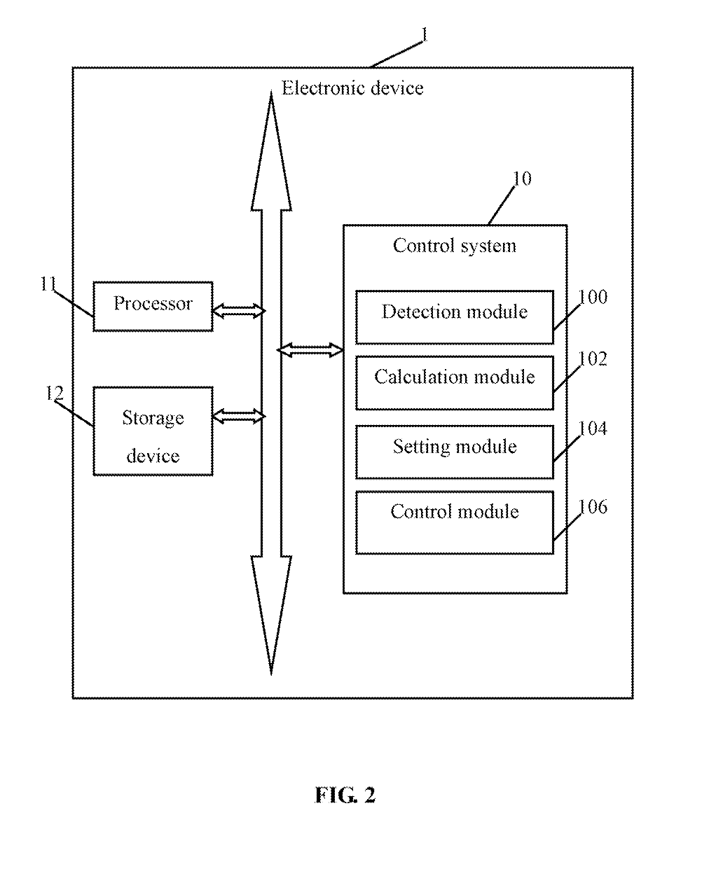

FIG. 2 is a block diagram of function modules of a control system 10 in the electronic device 1. The electronic device 1 further includes at least one processor 11 and a storage device 12. FIG. 2 illustrates only one example of the electronic device 1 that may include more or fewer components than illustrated, or have a different configuration of the various components.

In some embodiments, the control system 10 determines a startup sequence of the storage nodes 24 and turns off the storage server 2, when a total power of the storage server is greater than a threshold value. The control system 10 further controls the storage nodes 24 to start up according to the startup sequence when the storage server 2 is restarted, to avoid inrush current when the power supply 20 provides power to all of the storage nodes 24 simultaneously.

In one embodiment, the control system 10 may include computerized instructions in the form of one or more programs that are executed by the at least one processor 11 and stored in the storage device 12. The storage device 12 stores one or more programs, such as operating systems, applications of the electronic device 1, and various kinds of data. In some embodiments, the storage device 12 may be an external storage card, such as a memory stick, a smart media card, a compact flash card, a secure digital card, or any other type of memory storage device.

In one embodiment, the control system 10 may include one or more modules, for example, a detection module 100, a calculation module 102, a setting module 104, and a control module 106. In general, the word “module,” as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

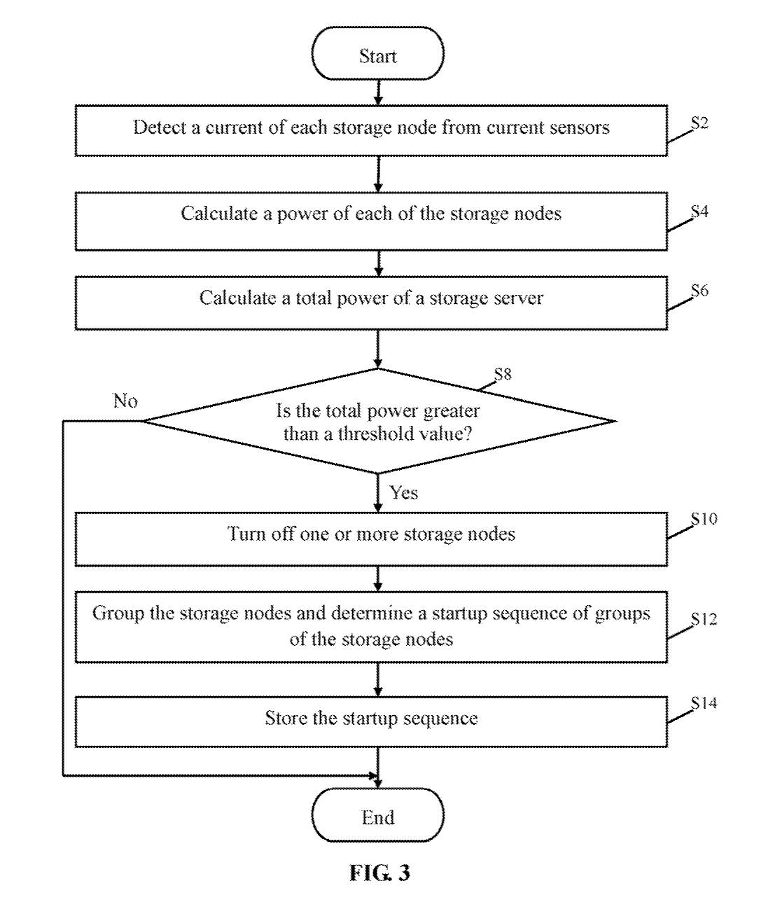

FIG. 3 is a flowchart of one embodiment of a method for determining a startup sequence using the control system 10. Depending on the embodiment, additional steps may be added, others removed, and the ordering of the steps may be changed.

In step S2, the detection module 100 detects a current drawn by each of the storage nodes 24 from the current sensors 22 when the storage server 2 is turned on.

In step S4, the calculation module 102 calculates a power of each of the storage nodes 24 according to the current drawn by each of the storage nodes 24 and a standard voltage of each of the storage devices 240 of each of the storage nodes 24. For example, a power of a specified storage node 24 is calculated by summing up respective power of storage devices 240 of the specified storage node 24. A power of each storage device 240 of the specified storage node 24 is calculated by multiplying the current of the specified storage node 24 by a standard voltage of each storage device 240. The standard voltage of each storage device 240 is a known parameter.

In step S6, the calculation module 102 calculates a total power of the storage server 2 according to the power drawn by each of the storage nodes. For example, the calculation module 102 may sum up all powers of the storage nodes 24 to calculate the total power of the storage server 2.

In step S8, the control module 106 determines whether the total power of the storage server 2 is greater than a threshold value. The threshold value is preset by the setting module 104. In some embodiments, the threshold value is less than or equal to a rated power of the power supply 20. For example, the rated power of the power supply 20 is 4000 watt, and the threshold value may be preset to be 3800 watt.

When the total power of the storage server 2 is greater than the threshold value, it is indicated that too many storage devices 240 have been started up simultaneously, and the power supply 20 cannot output the power to the storage server 2 normally. When the total power of the storage server 2 is greater than the threshold value, step S10 is executed. When the total power of the storage server 2 is less than or equal to the threshold value, the procedure ends.

In step S10, the control module 106 turns off one or more storage nodes 24, or turns off the storage server 2, to avoid an inrush of current on startup damaging the storage devices 240, the storage nodes 24, the storage server 2, the power supply 20 or other peripheral devices of the storage server 2.

In step S12, the setting module 104 groups the storage nodes 24 according to the power of each of the storage nodes 24 and the threshold value, and determines a startup sequence of groups of the storage nodes 24. In some embodiments, each group of the storage nodes 24 may have one or more storage nodes 24, and a power of each group of the storage nodes 24 is less than or equal to the threshold value.

When the setting module 104 determines the startup sequence, a startup power of a current group of the storage nodes 24 and other devices of the storage server 2, such as a display device and a processor, should be less than or equal to the rated power of the power supply 20 or the threshold value. Supposing that there are three groups of storage nodes 24, group A, group B and group C, and the startup sequence is “ABC.” A power drawn by group A is “A1,” a power drawn by group B is “B1,” and a power drawn by group C is “C1.” When the storage server 2 is turned on, group A is also started up, and a total power of the storage server 2 including the power “A1” should be less than or equal to the threshold value.

In other embodiments, the setting module 104 may further preset a delay time, such as 30 seconds. For example, after group A has been started up, group B may be started up after the preset delay time.

In step S14, the setting module 104 stores information of the groups of the storage nodes 24, and the startup sequence into the storage device 12.

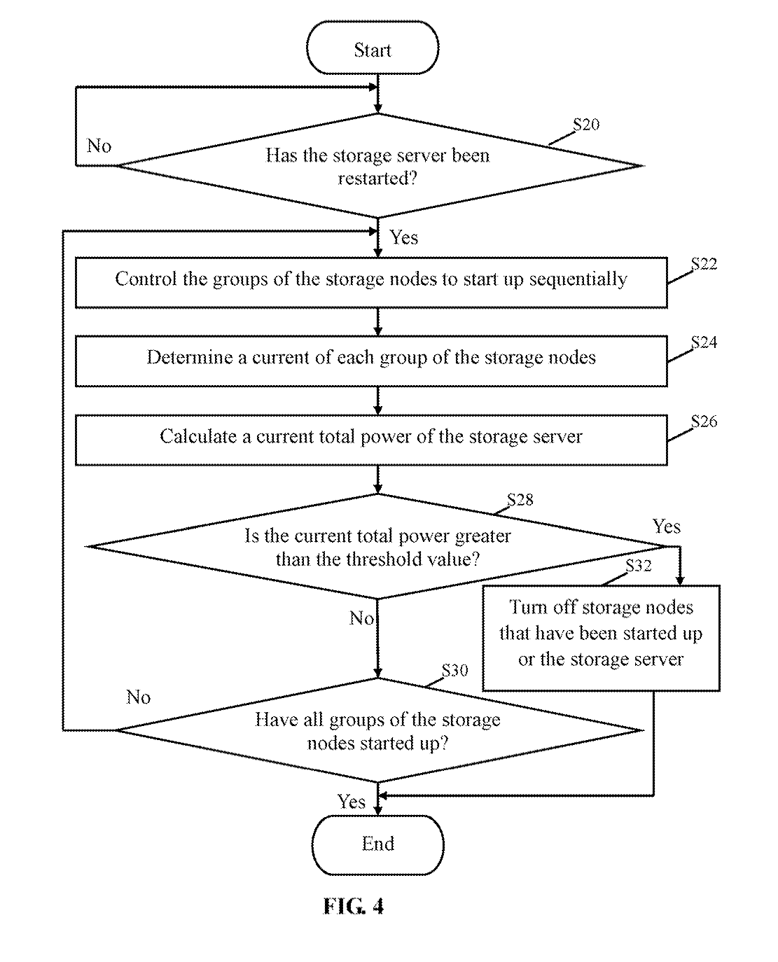

FIG. 4 is a flowchart of one embodiment of a method for controlling a startup current of the storage server using the control system. Depending on the embodiment, additional steps may be added, others removed, and the ordering of the steps may be changed.

In step S20, the detection module 100 determines whether the storage server 2 has been restarted after the startup sequence of the groups of the storage nodes 24 has been determined. When the storage server 2 has been restarted, step S22 is executed. When the storage server 2 has not been restarted, step S20 is repeated.

In step S22, the control module 106 controls the groups of the storage nodes 24 to start up sequentially according to the startup sequence. In some embodiments, when the total power calculated in step S6 is greater than the threshold value, the control module 106 turns off the storage server, and the setting module 104 groups the storage nodes 24 and determines the startup sequence of the groups of the storage nodes 24. Then the control module 106 starts up the groups of the storage nodes 24 according to the startup sequence.

In some embodiments, the control module 106 starts up a first group of the storage nodes 24 with the storage server 2, and then starts up a second group of the storage nodes 24 after the first group of the storage nodes 24 has finished starting up.

In other embodiments, the control module 106 may start up the groups of the storage nodes 24 according to the startup sequence and the delay time. For example, the first group of the storage nodes 24 has finished starting up at 8:00:00 AM, and the second group of the storage nodes 24 is controlled to start up at 8:00:30 AM. That is, the latter group of the storage nodes 24 is started up after the former group of the storage nodes 24 has started up and been running for the delay time.

In step S24, the detection module 100 determines a current of each group of the storage nodes 24 using the current sensors 22. If group A of the storage nodes 24 has one or more storage nodes 24, the detection module 100 detects current of the current sensors 22 corresponding to the one or more storage nodes 24, and then determines a current of the whole group of the storage nodes 24.

In step S26, the calculation module 102 calculates an instant total power of the storage server 2. In some embodiments, the instant total power of the storage server 2 is updated each time one group of the storage nodes 24 has been started up until all groups of the storage nodes 24 have been started up sequentially.

In step S28, the control module 106 determines whether the instant total power of the storage server 2 is greater than the threshold value. When the instant total power of the storage server 2 is greater than the threshold value, step S32 is executed. When the instant total power of the storage server 2 is less than or equal to the threshold value, step S30 is executed.

In step S30, the control module 106 determines whether all groups of the storage nodes 24 have been started up. When all groups of the storage nodes 24 have been started up, the procedure ends. When any group of the storage nodes 24 has not been started up, the procedure returns to step S22.

In step S32, the control module 106 turns off one or more storage nodes 24 or one or more groups of the storage nodes 24 that have been started up, or turns off the entire storage server 2, and the procedure ends. In other embodiments, after step S32, steps S12 to S14 as shown in FIG. 3 are executed again to re-group the storage nodes 24, and/or reset the startup sequence of the groups of the storage nodes 24.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for controlling a startup current of a storage server being executed by a processor of an electronic device, the storage server comprising a power supply, storage nodes and current sensors, each of the storage nodes comprising a plurality of storage devices, the storage nodes being connected to the power supply, and each of the current sensors being connected to one of the storage nodes, the method comprising:
detecting a current of each of the storage nodes from the current sensors when the storage server is turned on;
calculating a power of each of the storage nodes according to the current of each of the storage nodes and a standard voltage of each of the storage devices of each of the storage nodes;
calculating a total power of the storage server according to the power of each of the storage nodes;
turning off one or more storage nodes when the total power of the storage server is greater than a threshold value;
grouping the storage nodes according to the power of each of the storage nodes and the threshold value, and determining a startup sequence of groups of the storage nodes; and
controlling the groups of the storage nodes to start up according to the startup sequence when the storage server is restarted.

2. The method according to claim 1, wherein the power of each group of the storage nodes is less than or equal to the threshold value.

3. The method according to claim 1, further comprising:
presetting a delay time; and
controlling the groups of the storage nodes to start up according to the startup sequence and the delay time.

4. The method according to claim 1, further comprising:
determining a current of each group of the storage nodes using the current sensors when the storage server is restarted; and
calculating an instant total power of the storage server each time one group of the storage nodes has been started up until all groups of the storage nodes have been started up sequentially.

5. The method according to claim 4, further comprising:
turning off one or more storage nodes or one or more groups of the storage nodes that have been started up, or turning off the storage server when the instant total power of the storage server is greater than the threshold value.

6. The method according to claim 1, wherein the threshold value is less than or equal to a rated power of the power supply.

7. An electronic device being in connection to a storage server, the storage server comprising a power supply, storage nodes and current sensors, each of the storage nodes comprising a plurality of storage devices, the storage nodes being connected to the power supply, and each of the current sensors being connected to one of the storage nodes, the electronic device comprising:
at least one processor; and
a storage device storing a plurality of instructions, which when executed by the processor, causes the at least one processor to:
detect a current of each of the storage nodes from the current sensors when the storage server is turned on;
calculate a power of each of the storage nodes according to the current of each of the storage nodes and a standard voltage of each of the storage devices of each of the storage nodes;
calculate a total power of the storage server according to the power of each of the storage nodes;
turn off one or more storage nodes when the total power of the storage server is greater than a threshold value;
group the storage nodes according to the power of each of the storage nodes and the threshold value, and determine a startup sequence of groups of the storage nodes; and
control the groups of the storage nodes to start up according to the startup sequence when the storage server is restarted.

8. The electronic device according to claim 7, wherein the power of each group of the storage nodes is less than or equal to the threshold value.

9. The electronic device according to claim 7, wherein the at least one processor further:
preset a delay time; and
control the groups of the storage nodes to start up according to the startup sequence and the delay time.

10. The electronic device according to claim 7, wherein the at least one processor further:
determine a current of each group of the storage nodes using the current sensors when the storage server is restarted; and
calculate an instant total power of the storage server each time one group of the storage nodes has been started up until all groups of the storage nodes have been started up sequentially.

11. The electronic device according to claim 10, wherein the at least one processor further:
turn off one or more storage nodes or one or more groups of the storage nodes that have been started up, or turning off the storage server when the instant total power of the storage server is greater than the threshold value.

12. The electronic device according to claim 7, wherein the threshold value is less than or equal to a rated power of the power supply.

13. A non-transitory storage medium having stored thereon instructions that, when executed by a processor of an electronic device, causes the electronic device to perform a method for controlling a startup current of a storage server, the storage server comprising a power supply, storage nodes and current sensors, each of the storage nodes comprising a plurality of storage devices, the storage nodes being connected to the power supply, and each of the current sensors being connected to one of the storage nodes, the method comprising:
detecting a current of each of the storage nodes from the current sensors when the storage server is turned on;
calculating a power of each of the storage nodes according to the current of each of the storage nodes and a standard voltage of each of the storage devices of each of the storage nodes;
calculating a total power of the storage server according to the power of each of the storage nodes;
turning off one or more storage nodes when the total power of the storage server is greater than a threshold value;
grouping the storage nodes according to the power of each of the storage nodes and the threshold value, and determining a startup sequence of groups of the storage nodes; and
controlling the groups of the storage nodes to start up according to the startup sequence when the storage server is restarted.

14. The non-transitory storage medium according to claim 13, wherein the power of each group of the storage nodes is less than or equal to the threshold value.

15. The non-transitory storage medium according to claim 13, wherein the method further comprises:
presetting a delay time; and
controlling the groups of the storage nodes to start up according to the startup sequence and the delay time.

16. The non-transitory storage medium according to claim 13, wherein the method further comprises:
determining a current of each group of the storage nodes using the current sensors when the storage server is restarted; and
calculating an instant total power of the storage server each time one group of the storage nodes has been started up until all groups of the storage nodes have been started up sequentially.

17. The non-transitory storage medium according to claim 16, wherein the method further comprises:
turning off one or more storage nodes or one or more groups of the storage nodes that have been started up, or turning off the storage server when the instant total power of the storage server is greater than the threshold value.

18. The non-transitory storage medium according to claim 13, wherein the threshold value is less than or equal to a rated power of the power supply.
